(19) United States
(12) Patent Application Publication
(10) Pub. No.: US 2016/0342782 A1
(43) Pub. Date: Nov. 24, 2016

(54) BIOMETRIC AUTHENTICATION IN A HEAD MOUNTED DEVICE

(71) Applicant: DAQRI, LLC, Los Angeles, CA (US)

(72) Inventors: Brian Mullins, Altadena, CA (US); Matthew Kammerait, Studio City, CA (US); Christopher Broaddus, Mountain View, CA (US)

(21) Appl. No.: 15/158,473

(22) Filed: May 18, 2016

Related U.S. Application Data
(60) Provisional application No. 62/163,030, filed on May 18, 2015.

(51) Int. Cl. G06F 21/32; G02B 27/01

(52) U.S. Cl. CPC G06F 21/32; G02B 27/0176

(57) ABSTRACT

A head mounted device (HMD) includes a transparent display, a biometric sensor, and a processor. The transparent display displays virtual objects. The biometric sensor measures biometric data of a user of the HMD. The processor generates and renders a sequence of virtual objects in the transparent display, records the biometric data of the user of the HMD for each virtual object of the sequence of virtual objects displayed in the transparent display, and authenticates the user based on the biometric data.

### REFERENCE TO RELATED APPLICATION

This application claims the benefit of priority of U.S. Provisional Application No. 62/163,030 filed May 18, 2015, which is herein incorporated by reference in its entirety.

### TECHNICAL FIELD

The subject matter disclosed herein generally relates to a head mounted device. Specifically, the present disclosure addresses systems and methods for a biometric authentication system in a helmet.

### BACKGROUND

An augmented reality (AR) device can be used to generate and display data in addition to an image captured with the AR device. For example, AR is a live, direct, or indirect view of a physical, real-world environment whose elements are augmented by computer-generated sensory input such as sound, video, graphics or Global Positioning System (GPS) data. With the help of advanced AR technology (e.g., adding computer vision and object recognition) the information about the surrounding real world of the user becomes interactive. Device-generated (e.g., artificial) information about the environment and its objects can be overlaid on the real world.

### BRIEF DESCRIPTION OF THE DRAWINGS

Some embodiments are illustrated by way of example and not limitation in the figures of the accompanying drawings.

FIG. 1 is a block diagram illustrating an example of a network suitable for a head mounted device system, according to some example embodiments.

FIG. 2 is a block diagram illustrating an example embodiment of a head mounted device.

FIG. 3 is a block diagram illustrating examples of sensors.

FIG. 4 is a block diagram illustrating an example embodiment of a biometric authentication application.

FIG. 5 is a block diagram illustrating an example embodiment of a server.

FIG. 6 is a flowchart illustrating a method for operating a biometric authentication application, according to an example embodiment.

FIG. 7 is a flowchart illustrating a method for operating a biometric authentication application, according to another example embodiment.

FIG. 8A is an interaction diagram illustrating interactions between a head mounted device and a server for ocular authentication, according to an example embodiment.

FIG. 8B is an interaction diagram illustrating interactions between a head mounted device and a server for ocular authentication, according to another example embodiment.

FIG. 9A is an interaction diagram illustrating interactions between a head mounted device and a server for electroencephalogram (EEG)/electrocardiogram (ECG) authentication, according to an example embodiment.

FIG. 9B is an interaction diagram illustrating interactions between a head mounted device and a server for EEG/ECG authentication, according to another example embodiment.

FIG. 10A is a block diagram illustrating a biometric authentication using an ocular sensor, according to an example embodiment.

FIG. 10B is a block diagram illustrating a biometric authentication using an ocular sensor, according to another example embodiment.

FIG. 11A is a block diagram illustrating a biometric authentication using EEG/ECG sensors, according to an example embodiment.

FIG. 11B is a block diagram illustrating a biometric authentication using EEG/ECG sensors, according to another example embodiment.

FIG. 12A is a block diagram illustrating a front view of a head mounted device, according to some example embodiments.

FIG. 12B is a block diagram illustrating a side view of the head mounted device of FIG. 12A.

FIG. 13 is a block diagram illustrating components of a machine, according to some example embodiments, able to read instructions from a machine-readable medium and perform any one or more of the methodologies discussed herein.

### DETAILED DESCRIPTION

Example methods and systems are directed to a biometric authentication system of a head mounted device (HMD). Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In one example embodiment, a HMD includes a helmet, a transparent display, a biometric sensor, and a processor. The transparent display includes lenses that are disposed in front of the user's eyes to display virtual objects. The biometric sensor includes, for example, an ocular camera attached to the transparent display and directed towards the eyes of the user. In another example, the biometric sensor includes EEG/ECG sensors disposed inside a perimeter of the helmet so that the EEG/ECG sensors connect to the forehead of the user when the helmet is worn. The biometric sensor generates biometric data based on, for example, the blood vessel pattern in the retina of an eye of the user, the structure pattern of the iris of an eye of the user, the brain wave pattern of the user, or a combination thereof. The processor renders virtual objects in the transparent display, and records the biometric data of the user in response to the user looking at a corresponding virtual object. The processor authenticates the user based on the biometric data for the corresponding virtual objects. Once the user is authenticated, the user can view additional virtual objects. Different types of virtual objects may be assigned to different types of users. For example, once the HMD determines that the authenticated user is an executive of a company, the HMD provides the user with access to more sensitive documents and virtual objects that are displayed in the transparent display. In other example embodiments, the geographic location of the HMD may trigger an authentication process for the user of the HMD. For example, a GPS unit in the HMD may determine that the user is at a geographic location associated with virtual objects including sensitive material that may need authentication from the user to access the sensitive material.

In one example embodiment, the HMD renders a series of virtual objects in the transparent display during an authentication process. Each virtual object may be displayed at a different location in the transparent display. For example, a first virtual object may be displayed in a top part of the transparent display for a brief period of time (e.g., one second). After the first virtual object disappears from the transparent display, a second virtual object may be displayed in a bottom part of the transparent display for another brief period of time. The first virtual object may be the same or different from the second virtual object.

The HMD may record biometric data of the user for each location of the virtual objects in the transparent display. For example, the HMD records a first set of biometric data of the user when the first virtual object is displayed in the top part of the transparent display. The HMD records a second set of biometric data of the user when the second virtual object is displayed in a bottom part of the transparent display.

Once the biometric data are recorded for the different locations, the HMD compares the biometric data of the user for each location of the virtual objects against reference biometric data of the user for the corresponding locations of the virtual objects to authenticate the user. For example, the HMD retrieves a first reference biometric data associated with the location of the first virtual object that was displayed in the top part of the transparent display. The HMD then compares the first reference biometric data with the recorded first set of biometric data of the user. The first reference biometric data may have been previously determined for the user. Similarly, the HMD retrieves a second reference biometric data associated with the location of the second virtual object that was displayed in the bottom part of the transparent display. The HMD then compares the second reference biometric data with the recorded second set of biometric data of the user. The second reference biometric data may also have been previously determined for the user. The user of the HMD is authenticated if at least one of the first and second reference biometric data matches the recorded first and second set of biometric data. In another example, the user of the HMD is authenticated if all reference biometric data matches all recorded sets of biometric data.

In another example embodiment, the HMD records the biometric data of the user for each different location of the virtual objects in the transparent display, and generates composite biometric data based on the biometric data of the user for the different locations of the virtual objects. For example, the composite biometric data may include an average of the biometric data for the different locations of the virtual objects. It will be appreciated that the composite biometric data may be computed using a variety of different algorithms (e.g., statistical algorithm, hash algorithm) applied to the biometric data for the different locations of the virtual objects. The HMD then compares the composite biometric data of the user against reference biometric data of the user. The reference biometric data of the user may have been previously generated and stored in the HMD during a configuration process. The user of the HMD is authenticated if the composite biometric data of the user matches the reference biometric data of the user.

The HMD may also render a series of different virtual objects during an authentication process. The HMD records the biometric data of the user for the series of different virtual objects displayed in the transparent display. For example, the HMD records a first set of biometric data of the user when the first virtual object is displayed in the transparent display. The HMD records a second set of biometric data of the user when the second virtual object is displayed in the transparent display.

Once the biometric data are recorded for the series of different virtual objects, the HMD compares the biometric data of the user for each virtual object against reference biometric data of the user for the corresponding virtual object to authenticate the user. For example, the HMD retrieves a first reference biometric data associated with the first virtual object displayed in the transparent display. The HMD then compares the first reference biometric data with the recorded first set of biometric data of the user. The first reference biometric data may have been previously computed for the user. Similarly, the HMD retrieves a second reference biometric data associated with the second virtual object that was displayed in the transparent display. The HMD then compares the second reference biometric data with the recorded second set of biometric data of the user. The second reference biometric data may have been previously generated for the user. The user of the HMD is authenticated if at least one of the first and second reference biometric data matches the recorded first and second set of biometric data. In another example, the user of the HMD is authenticated if all reference biometric data matches all recorded sets of biometric data.

In another example embodiment, the HMD records the biometric data of the user for the series of different virtual objects in the transparent display, and generates composite biometric data based on the biometric data of the user for the corresponding virtual object. For example, the composite biometric data may include an average of the biometric data for the series of different virtual objects. It will be appreciated that the composite biometric data may be computed using a variety of different algorithms applied to the biometric data for the series of different locations of the virtual objects. The HMD then compares the composite biometric data of the user against reference biometric data of the user. The reference biometric data of the user may have been previously computed and stored in the HMD. The user of the HMD is authenticated if the composite biometric data of the user matches the reference biometric data of the user.

In another example embodiment, the HMD includes an augmented reality (AR) application that identifies an object in an image captured with the camera, retrieves a three-dimensional model of a virtual object from the augmented reality content based on the identified object, and renders the three-dimensional model of the virtual object in the transparent display lens. The virtual object is perceived as an overlay on the real world object.

The HMD may include a helmet with a display surface that can be retracted inside the helmet and extended outside the helmet to allow a user to view the display surface. The position of the display surface may be adjusted based on an eye level of the user. The display surface includes a display lens capable of displaying augmented reality (AR) content. The helmet may include a computing device such as a hardware processor with an AR application that allows the user wearing the helmet to experience information, such as in the form of a virtual object such as a three-dimensional (3D) virtual object overlaid on an image or a view of a physical object (e.g., a gauge) captured with a camera in the helmet. The helmet may include optical sensors. The physical object may include a visual reference (e.g., a recognized image, pattern, or object, or unknown objects) that the AR application can identify using predefined objects or machine vision. A visualization of the additional information (also referred to as AR content), such as the 3D virtual object overlaid or engaged with a view or an image of the physical object, is generated in the display lens of the helmet. The display lens may be transparent to allow the user to see through the display lens. The display lens may be part of a visor or face shield of the helmet or may operate independently from the visor of the helmet. The 3D virtual object may be selected based on the recognized visual reference or captured image of the physical object. A rendering of the visualization of the 3D virtual object may be based on a position of the display relative to the visual reference. Other AR applications allow the user to experience visualization of the additional information overlaid on top of a view or an image of any object in the real physical world. The virtual object may include a 3D virtual object and/or a two-dimensional (2D) virtual object. For example, the 3D virtual object may include a 3D view of an engine part or an animation. The 2D virtual object may include a 2D view of a dialog box, menu, or written information such as statistics information for properties or physical characteristics of the corresponding physical object (e.g., temperature, mass, velocity, tension, stress). The AR content (e.g., image of the virtual object, virtual menu) may be rendered at the helmet or at a server in communication with the helmet. In one example embodiment, the user of the helmet may navigate the AR content using audio and visual inputs captured at the helmet or other inputs from other devices, such as a wearable device. For example, the display lenses may extract or retract based on a voice command of the user, a gesture of the user, a position of a watch in communication with the helmet, etc.

In another example embodiment, a non-transitory machine-readable storage device may store a set of instructions that, when executed by at least one processor, causes the at least one processor to perform the method operations discussed within the present disclosure.

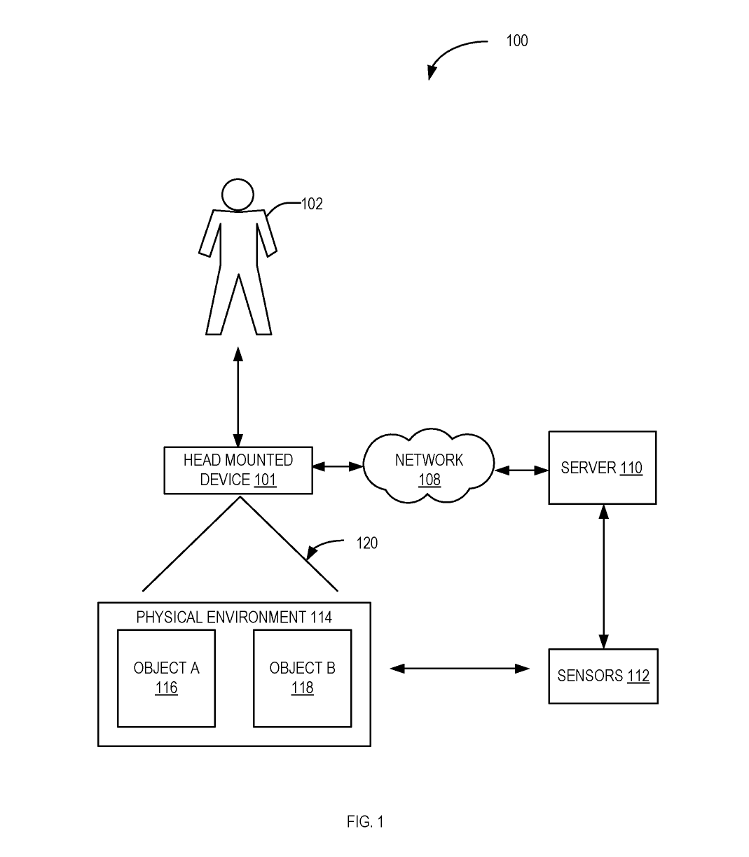

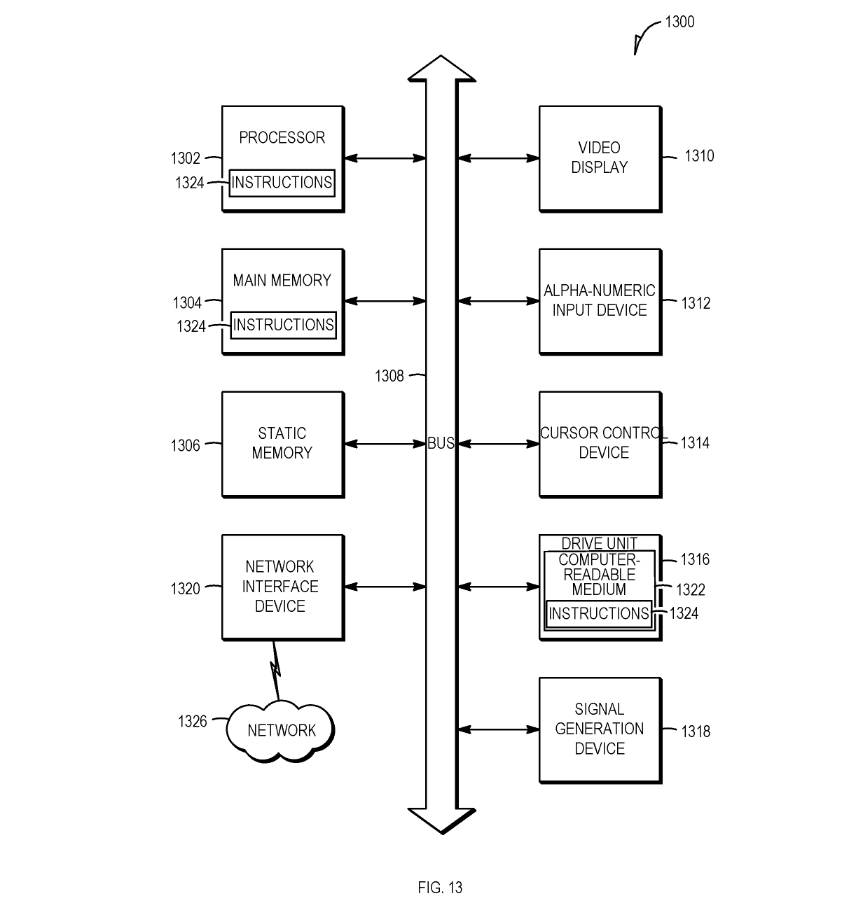

FIG. 1 is a network diagram illustrating a network environment 100 suitable for operating an AR application of a HMD with display lenses, according to some example embodiments. The network environment 100 includes a HMD 101 and a server 110, communicatively coupled to each other via a network 108. The HMD 101 and the server 110 may each be implemented in a computer system, in whole or in part, as described below with respect to FIG. 13.

The server 110 may be part of a network-based system. For example, the network-based system may be or include a cloud-based server system that provides AR content (e.g., augmented information including 3D models of virtual objects related to physical objects captured by the HMD 101) to the HMD 101.

The HMD 101 may include a helmet that a user 102 may wear to view the AR content related to captured images of several physical objects (e.g., object A 116, object B 118) in a real-world physical environment 114. In one example embodiment, the HMD 101 includes a computing device with a camera and a display (e.g., smart glasses, smart helmet, smart visor, smart face shield, smart contact lenses). The computing device may be removably mounted to the head of the user 102. In one example, the display may be a screen that displays what is captured with a camera of the HMD 101. In another example, the display of the HMD 101 may be transparent, such as in the visor or face shield of a helmet, or a display lens distinct from the visor or face shield of the helmet.

The user 102 may be a user of an AR application in the HMD 101 and at the server 110. The user 102 may be a human user (e.g., a human being), a machine user (e.g., a computer configured by a software program to interact with the HMD 101), or any suitable combination thereof (e.g., a human assisted by a machine or a machine supervised by a human). The user 102 is not part of the network environment 100, but is associated with the HMD 101. The AR application may provide the user 102 with an AR experience triggered by identified objects in the physical environment 114. The physical environment 114 may include identifiable objects such as a 2D physical object (e.g., a picture), a 3D physical object (e.g., a factory machine), a location (e.g., at the bottom floor of a factory), or any references (e.g., perceived corners of walls or furniture) in the real-world physical environment 114. The AR application may include computer vision recognition to determine corners, objects, lines, and letters. The user 102 may point a camera of the HMD 101 to capture an image of the objects A 116 and B 118 in the physical environment 114.

In one example embodiment, the objects A 116, B 118 in the image are tracked and recognized locally in the HMD 101 using a local context recognition dataset or any other previously stored dataset of the AR application of the HMD 101. The local context recognition dataset module may include a library of virtual objects associated with real-world physical objects A 116, B 118 or references. In one example, the HMD 101 identifies feature points in an image of the objects A 116, B 118 to determine different planes (e.g., edges, corners, surface, dial, letters). The HMD 101 may also identify tracking data related to the objects A 116, B 118 (e.g., GPS location of the HMD 101, orientation, distances to objects A 116, B 118). If the captured image is not recognized locally at the HMD 101, the HMD 101 can download additional information (e.g., 3D model or other augmented data) corresponding to the captured image, from a database of the server 110 over the network 108.

In another embodiment, the objects A 116, B 118 in the image are tracked and recognized remotely at the server 110 using a remote context recognition dataset or any other previously stored dataset of an AR application in the server 110. The remote context recognition dataset module may include a library of virtual objects or augmented information associated with real-world physical objects A 116, B 118 or references.

Sensors 112 may be associated with, coupled to, or related to the objects A 116 and B 118 in the physical environment 114 to measure a location, information, or captured readings from the objects A 116 and B 118. Examples of captured readings may include, but are not limited to, weight, pressure, temperature, velocity, direction, position, intrinsic and extrinsic properties, acceleration, and dimensions. For example, sensors 112 may be disposed throughout a factory floor to measure movement, pressure, orientation, and temperature. The server 110 can compute readings from data generated by the sensors 112. The server 110 can generate virtual indicators such as vectors or colors based on data from sensors 112. Virtual indicators are then overlaid on top of a live image of the objects A 116 and B 118 to show data related to the objects A 116 and B 118. For example, the virtual indicators may include arrows with shapes and colors that change based on real-time data. The visualization may be provided to the HMD 101 so that the HMD 101 can render the virtual indicators in a display of the HMD 101. In another embodiment, the virtual indicators are rendered at the server 110 and streamed to the HMD 101. The HMD 101 displays the virtual indicators or visualization corresponding to a display of the physical environment 114 (e.g., data is visually perceived as displayed adjacent to the objects A 116 and B 118).

The sensors 112 may include other sensors used to track the location, movement, and orientation of the HMD 101 externally without having to rely on the sensors 112 internal to the HMD 101. The sensors 112 may include optical sensors (e.g., depth-enabled 3D camera), wireless sensors (Bluetooth, Wi-Fi), GPS sensor, and audio sensors to determine the location of the user 102 having the HMD 101, distance of the user 102 to the tracking sensors 112 in the physical environment 114 (e.g., sensors 112 placed in corners of a venue or a room), the orientation of the HMD 101 to track what the user 102 is looking at (e.g., direction at which the HMD 101 is pointed, HMD 101 pointed towards a player on a tennis court, HMD 101 pointed at a person in a room).

In another embodiment, data from the sensors 112 and internal sensors in the HMD 101 may be used for analytics data processing at the server 110 (or another server) for analysis on usage and how the user 102 is interacting with the physical environment 114. Live data from other servers may also be used in the analytics data processing. For example, the analytics data may track at what locations (e.g., points or features) on the physical or virtual object the user 102 has looked, how long the user 102 has looked at each location on the physical or virtual object, how the user 102 moved with the HMD 101 when looking at the physical or virtual object, which features of the virtual object the user 102 interacted with (e.g., such as whether a user 102 tapped on a link in the virtual object), and any suitable combination thereof. The HMD 101 receives a visualization content dataset related to the analytics data. The HMD 101 then generates a virtual object with additional or visualization features, or a new experience, based on the visualization content dataset.

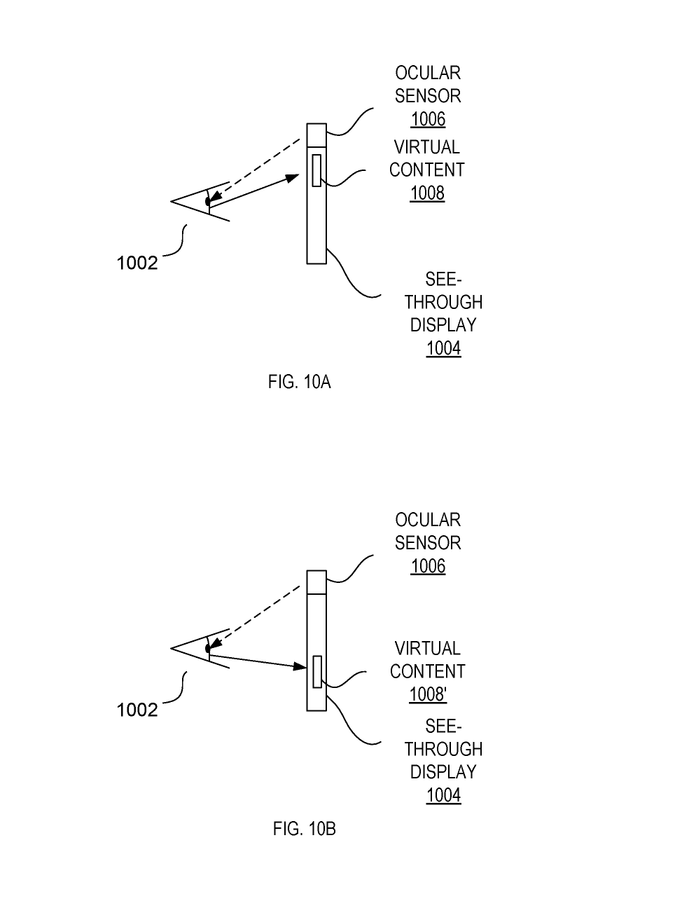

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 108 may be any network that enables communication between or among machines (e.g., the server 110), databases, and devices (e.g., HMD 101). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof.

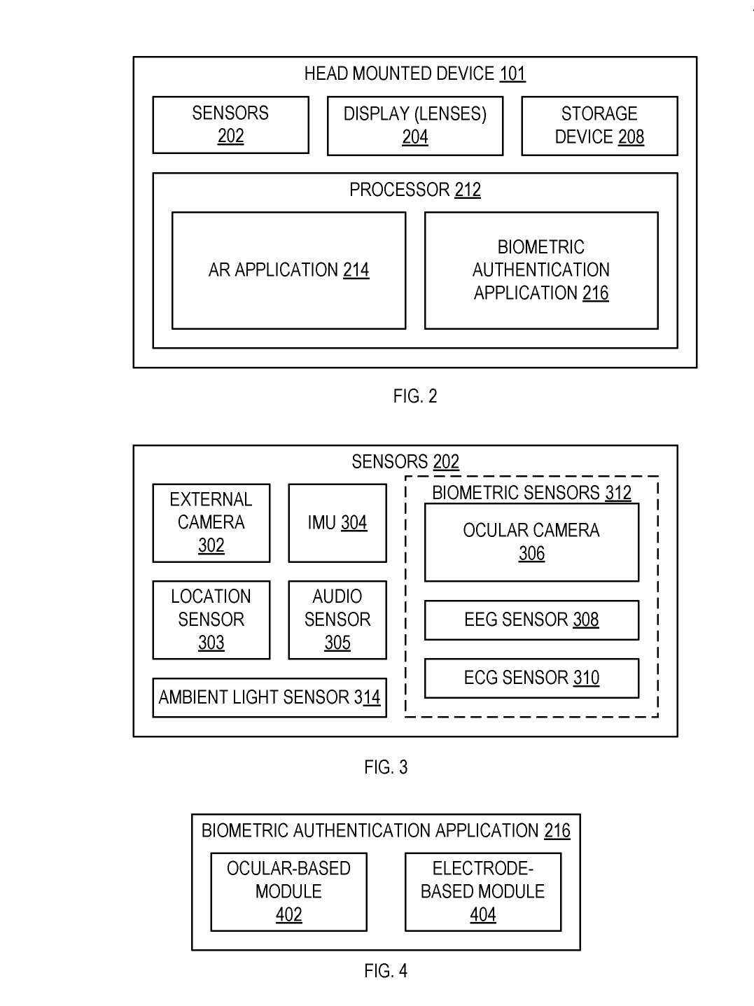

FIG. 2 is a block diagram illustrating modules (e.g., components) of the HMD 101, according to some example embodiments. The HMD 101 may be a helmet that includes sensors 202, a display 204, a storage device 208, and a processor 212. The HMD 101 may not be limited to a helmet and may include any type of device that can be worn on the head of a user, such as a headband, a hat, or a visor.

The sensors 202 may be used to generate internal tracking data of the HMD 101 to determine a position and an orientation of the HMD 101. The position and the orientation of the HMD 101 may be used to identify real-world objects in a field of view of the HMD 101. For example, a virtual object may be rendered and displayed in the display 204 when the sensors 202 indicate that the HMD 101 is oriented towards a real-world object (e.g., when the user 102 looks at object A 116) or in a particular direction (e.g., when the user 102 tilts his head to watch his wrist). The HMD 101 may display a virtual object also based on a geographic location of the HMD 101. For example, a set of virtual objects may be accessible when the user 102 of the HMD 101 is located in a particular building. In another example, virtual objects, including sensitive material, may be accessible when the user 102 of the HMD 101 is located within a predefined area associated with the sensitive material and the user 102 is authenticated. Different levels of content of the virtual objects may be accessible based on a credential level of the user 102. For example, a user who is an executive of a company may have access to more information or content in the virtual objects than a manager at the same company. The sensors 202 may be used to authenticate the user 102 prior to providing the user 102 with access to the sensitive material (e.g., information displayed in as a virtual object such as a virtual dialog box in a transparent display). Authentication may be achieved via a variety of methods such as providing a password or an authentication token, or using sensors 202 to determine biometric data unique to the user 102. The biometric method is explained in more detail below.

FIG. 3 is a block diagram illustrating examples of sensors. For example, the sensors 202 may include an external camera 302, a location sensor 303, an IMU 304, an audio sensor 305, an ambient light sensor 314, and biometric sensors 312. It is noted that the sensors 202 described herein are for illustration purposes. Sensors 202 are thus not limited to the ones described.

The external camera 302 includes an optical sensor(s) (e.g., camera) that may encompass different spectrums. For example, the external camera 302 may include an infrared camera or a full-spectrum camera. The external camera 302 may include rear-facing camera(s) and front-facing camera(s) disposed in the HMD 101. The front-facing camera(s) may be used to capture a front field of view of the HMD 101 while the rear-facing camera(s) may be used to capture a rear field of view of the HMD 101. The pictures captured with the front- and rear-facing cameras may be combined to recreate a 360-degree view of the physical environment 114 around the HMD 101.

The location sensor 303 may determine a geolocation of the HMD 101 using a variety of techniques such as near field communication, GPS, Bluetooth, Wi-Fi. For example, the location sensor 303 may generate geographic coordinates of the HMD 101.

The IMU 304 may include a gyroscope and an inertial motion sensor to determine an orientation and movement of the HMD 101. For example, the IMU 304 may measure the velocity, orientation, and gravitational forces on the HMD 101. The IMU 304 may also detect a rate of acceleration using an accelerometer and changes in angular rotation using a gyroscope.

The audio sensor 305 may include a microphone. For example, the microphone may be used to record a voice command from the user (e.g., user 102) of the HMD 101. In other examples, the microphone may be used to measure an ambient noise (e.g., measure intensity of the background noise, identify specific type of noises such as explosions or gunshot noises).

The ambient light sensor 314 may determine an ambient light intensity around the HMD 101. For example, the ambient light sensor 314 measures the ambient light in a room in which the HMD 101 is located.

The biometric sensors 312 include sensors configured to measure biometric data unique to the user 102 of the HMD 101. In one example embodiment, the biometric sensors 312 include an ocular camera 306, an EEG (electroencephalogram) sensor 308, and an ECG (electrocardiogram) sensor 310. It is noted that the biometric sensors 312 described herein are for illustration purposes. Biometric sensors 312 are thus not limited to the ones described.

In one example embodiment, the ocular camera 306 includes an infrared (IR) camera configured to capture an image of a retina of the user 102. The IR camera may be used to perform a retinal scan to map unique patterns of the retina of the user 102. Blood vessels within the retina absorb light more readily than the surrounding tissue in the retina and therefore can be identified with IR lighting. The IR camera may cast a beam of IR light into the user's eye as the user 102 looks through the display 204 (e.g., lenses) towards virtual objects rendered in the display 204. The beam of IR light traces a path on the retina of the user 102. Because retinal blood vessels absorb more of the IR light than the rest of the eye, the amount of reflection varies during the retinal scan. The pattern of variations may be used as a biometric data unique to the user 102.

In another example embodiment, the ocular camera 306 may be a camera configured to capture an image of an iris in the eye of the user 102. In response to the amount of light entering the eye, muscles attached to the iris expand or contract the aperture at the center of the iris, known as the pupil. The expansion and contraction of the pupil depends on the amount of ambient light. The ocular camera 306 may use iris recognition as a method for biometric identification. The complex pattern on the iris of the eye of the user 102 is unique and can be used to identify the user 102. The ocular camera 306 may cast infrared light to acquire images of detailed structures of the iris of the eye of the user 102. Biometric algorithms may be applied to the image of the detailed structures of the iris to identify the user 102.

In another example embodiment, the ocular camera 306 includes an IR pupil dimension sensor that is pointed at an eye of the user 102 to measure the size of the pupil of the user 102. The IR pupil dimension sensor may sample the size of the pupil (e.g., using an IR camera) on a periodic basis or based on predefined triggered events (e.g., the user 102 walks into a different room, sudden changes in the ambient light, or the like).

The EEG sensor 308 includes, for example, electrodes that, when in contact with the skin of the head of the user 102, measure electrical activity of the brain of the user 102. The EEG sensor 308 may also measure the electrical activity and wave patterns through different bands of frequency (e.g., Delta, Theta, Alpha, Beta, Gamma, Mu). EEG signals may be used to authenticate the user 102 based on fluctuation patterns unique to the user 102.

The ECG sensor 310 includes, for example, electrodes that measure a heart rate of the user 102. In particular, the ECG sensor 310 measures the cardiac rhythm of the user 102. A biometric algorithm is applied to the user 102 to identify and authenticate the user 102. In one example embodiment, the EEG sensors 308 and ECG sensor 310 may be combined into a same set of electrodes to measure both brain electrical activity and heart rate. The set of electrodes may be disposed around the helmet so that the set of electrodes comes into contact with the skin of the user 102 when the user 102 wears the helmet 101.

Referring back to FIG. 2, the display 204 may include a display surface or lens capable of displaying AR content (e.g., images, video) generated by the processor 212. The display 204 may be transparent so that the user 102 can see through the display 204 (e.g., such as in a head-up display).

The storage device 208 stores a database of reference biometric data, corresponding user identification, and user privilege level. The reference biometric data may include biometric data that was previously captured and associated with a user during a configuration process. The reference biometric data may include a set of biometric data associated with each location of the virtual object in the display 204. In another example, the reference biometric data may include a set of biometric data associated with each virtual object rendered in the display 204. The reference biometric data may include a composite biometric data based on the sets of biometric data. The reference biometric data may include a unique identifier based on the biometric data of the user 102. The user identification may include the name and title of the user 102 (e.g., John Doe, VP of engineering). The user privilege level may identify which content the user 102 may have access to (e.g., access level 5 means that the user 102 may have access to content in virtual objects that are tagged with level 5). Other tags or metadata may be used to identify the user privilege level (e.g., “classified”, “top secret”, “public”).

The storage device 208 may also store a database of identifiers of wearable devices capable of communicating with the HMD 101. In another embodiment, the database may also include visual references (e.g., images) and corresponding experiences (e.g., 3D virtual objects, interactive features of the 3D virtual objects). The database may include a primary content dataset, a contextual content dataset, and a visualization content dataset. The primary content dataset includes, for example, a first set of images and corresponding experiences (e.g., interaction with 3D virtual object models). For example, an image may be associated with one or more virtual object models. The primary content dataset may include a core set of images or the most popular images determined by the server 110. The core set of images may include a limited number of images identified by the server 110. For example, the core set of images may include the images depicting covers of the ten most viewed devices and their corresponding experiences (e.g., virtual objects that represent the ten most sensing devices in a factory floor). In another example, the server 110 may generate the first set of images based on the most popular or often scanned images received at the server 110. Thus, the primary content dataset does not depend on objects A 116, B 118 or images scanned by the HMD 101.

The contextual content dataset includes, for example, a second set of images and corresponding experiences (e.g., three-dimensional virtual object models) retrieved from the server 110. For example, images captured with the HMD 101 that are not recognized (e.g., by the server 110) in the primary content dataset are submitted to the server 110 for recognition. If the captured image is recognized by the server 110, a corresponding experience may be downloaded at the HMD 101 and stored in the contextual content dataset. Thus, the contextual content dataset relies on the contexts in which the HMD 101 has been used. As such, the contextual content dataset depends on objects or images scanned by the AR application 214 of the HMD 101.

In one example embodiment, the HMD 101 may communicate over the network 108 with the server 110 to access a database of reference biometric data or identifiers at the server 110 to compare with the biometric data of the user 102 and authenticate the user 102. In another example embodiment, the HMD 101 retrieves a portion of a database of visual references, corresponding 3D virtual objects, and corresponding interactive features of the 3D virtual objects.

The processor 212 may include an AR application 214 and a biometric authentication application 216. The AR application 214 generates a display of information related to the objects A 116, B 118. In one example embodiment, the AR application 214 generates a visualization of information related to the objects A 116, B 118 when the HMD 101 captures an image of the objects A 116, B 118 and recognizes the objects A 116, B 118, or when the HMD 101 is in proximity to the objects A 116, B 118. For example, the AR application 214 generates a display of a holographic or virtual menu visually perceived as a layer on the objects A 116, B 118.

The biometric authentication application 216 may determine biometric data unique to the user 102 and provide access to the virtual content in the AR application 214 based on an authentication of the user 102. For example, the virtual content may be accessible by a limited number of users. The users may be identified and authenticated based on the biometric data collected from the HMD 101. The biometric authentication application 216 may use the AR application 214 to generate virtual objects in the display 204 as part of the authentication process. The biometric authentication application 216 generates biometric data of the user 102 based on the virtual objects rendered in the display 204, the relative location of the virtual objects rendered in the display 204, or a combination thereof.

FIG. 4 is a block diagram illustrating an example embodiment of the biometric authentication application 216. The biometric authentication application 216 is shown by way of example to include an ocular-based module 402 and an electrode-based module 404. The ocular-based module 402 authenticates the user (e.g., user 102) based on the biometric data obtained from the ocular camera 306. For example, the ocular-based module 402 generates biometric data using a retinal scan method or an iris scan method as a method of authentication. The electrode-based module 404 authenticates the user 102 based on the biometric data obtained from the EEG sensor 308 and ECG sensor 310. For example, the electrode-based module 404 generates biometric data using variation in electrical signals from electrodes connected to the skin of the user 102 as a method of authentication.

In one example embodiment, the biometric authentication application 216 starts an authentication process by requesting the AR application 214 to render virtual objects in different locations in the display 204. For example, the AR application 214 may render the same virtual object or a series of different virtual objects at different locations in the display 204. One virtual object may be displayed at a time in the display 204. For example, a virtual crosshair may be displayed in a top part of the display 204. When the eyes of the user 102 are pointed towards the virtual crosshair, the ocular camera 306 captures a picture of the retina or the iris of the user 102. The biometric authentication application 216 then instructs the AR application 214 to display the virtual crosshair in another location of the display 204, for example, at the bottom part of the display 204. When the eyes of the user 102 are pointed towards the virtual crosshair at the bottom part of the display 204, the ocular camera 306 captures another picture of the retina or the iris of the user 102. Therefore, the ocular camera 306 captures a series of pictures of the retina or iris based on the user 102 looking at different directions.

The AR application 214 may display different virtual objects at each location in the display 204. For example, the AR application 214 may render a virtual arrow pointing down at the bottom part of the display 204, a virtual arrow pointing up at the top part of the display 204, a virtual arrow pointing left at the left part of the display 204, and a virtual arrow pointing right at the right part of the display 204. Every time the user 102 looks a different direction, the ocular camera 306 captures a picture of the retina or the iris of the user 102. The biometric authentication application 216 generates biometric data for each picture of the retina or iris by applying a biometric algorithm based on the structure of the blood vessels in the retina or the pattern of the iris. In another example embodiment, the biometric authentication application 216 generates composite biometric data for all the pictures by combining the biometric data for each picture. Alternatively, the biometric authentication application 216 generates a composite picture of the retina or iris based on the different pictures. The biometric authentication application 216 then applies the biometric algorithm to the composite picture of the retina or iris to generate the composite biometric data.

The biometric authentication application 216 accesses a library of biometric data and corresponding users in the storage device 208 to authenticate the user 102. For example, the library may also include virtual object or content access levels corresponding to each user. The library of biometric data may be stored in the storage device 208. The biometric authentication application 216 compares the biometric data from each picture with the biometric data in the storage device 208 to find a corresponding user. The biometric authentication application 216 can identify the user 102 when the biometric data from the biometric authentication application 216 matches the biometric data from the storage device 208. Furthermore, once the user (e.g., user 102) has been identified and authenticated, the biometric authentication application 216 determines the content access level of the user. The AR application 214 renders virtual object or content in the display 204 based on the content access level of the user.

In another example embodiment, the biometric authentication application 216 starts an authentication process by requesting the AR application 214 to render different virtual objects in the display 204. For example, the AR application 214 may render a series of different virtual objects at the same or different locations in the display 204. One virtual object may be displayed at a time in the display 204. For example, a virtual sun may be displayed in the display 204. The electrode-based module 404 measures electrical activity of the brain of the user 102 when the virtual sun is displayed in the display 204. In another example, the virtual object may be associated with an audio soundtrack. The AR application 214 may generate classical music while displaying the virtual sun. The electrode-based module 404 measures electrical activity of the brain of the user 102 while the user 102 listens to the audio soundtrack and looks at the virtual sun in the display 204. After the electrode-based module 404 captures electrical activity of the brain of the user 102, the AR application 214 removes the virtual sun and displays another virtual object (e.g., a virtual face of a character). The electrode-based module 404 measures electrical activity of the brain of the user 102 while the user 102 looks at the virtual sun or other virtual object in the display 204.

Therefore, the electrode-based module 404 captures a set of electrical signals based on the user 102 looking at different virtual objects in the display 204. The AR application 214 may display the same or different virtual objects in the display 204. Every time the user 102 looks a different virtual object, the electrode-based module 404 captures electrical activity of the brain of the user 102. The biometric authentication application 216 generates biometric data for each set of electrical activity by applying a biometric algorithm based on the electrical activity pattern unique to the user 102. For example, the biometric authentication application 216 generates biometric data for each set of electrical activity by applying a biometric algorithm to determine a pattern unique to the user 102 based on the electrical activity pattern of the brain of the user 102 using the EEG sensor 308 or the heart rate pattern of the user 102 using the ECG sensor 310.

In another example embodiment, the biometric authentication application 216 generates composite biometric data for all the sets of electrical signals by combining the biometric data for each set of electrical signals associated with a virtual object. Alternatively, the biometric authentication application 216 generates a composite set of electrical signals based on the different set of electrical signals. The biometric authentication application 216 then applies the biometric algorithm to the composite set of electrical signals to generate the composite biometric data.

The biometric authentication application 216 accesses a library of biometric data and corresponding users in the storage device 208 and compares the biometric data from each set of electrical signals with the biometric data in the storage device 208 to authenticate a corresponding user (e.g., user 102). The biometric authentication application 216 identifies the user 102 when the biometric data generated by the biometric authentication application 216 matches the biometric data from the storage device 208. Furthermore, once the user 102 has been identified and authenticated, the biometric authentication application 216 determines the content access level of the user 102. The AR application 214 renders virtual objects or content in the display 204 based on the content access level of the user 102.

In another example embodiment, the HMD 101 further includes a dynamic lighting system (not shown) that communicates with the ambient light sensor 314 in the HMD 101 to control and adjust a color and an output of a lighting element (e.g., LED) in the HMD 101 based on the measured ambient light and the dimensions of the pupils of the user 102. The lighting element may be directed toward a field of view of the user 102 or may be directed towards the eyes of the user 102. For example, the biometric authentication application 216 may measure the biometric data from the pupil or iris of the user 102 at different intensities of the lighting elements. In another example, the intensity of the lighting element may be increased or decreased incrementally until the pupil size is within a preset range associated with a retinal or iris scan procedure.

The dynamic lighting system may adjust the color and intensity of the lighting element during the retinal or iris scan procedure. The biometric authentication application 216 generates a set of biometric data during a scanning procedure associated with a set of predefined configurations. For example, the scanning procedure may include measuring the structure of the iris of the user 102 at different preset light intensities or colors of the lighting element.

Any one or more of the modules described herein may be implemented using hardware (e.g., a processor 212 of a machine) or a combination of hardware and software. For example, any module described herein may configure a processor 212 to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

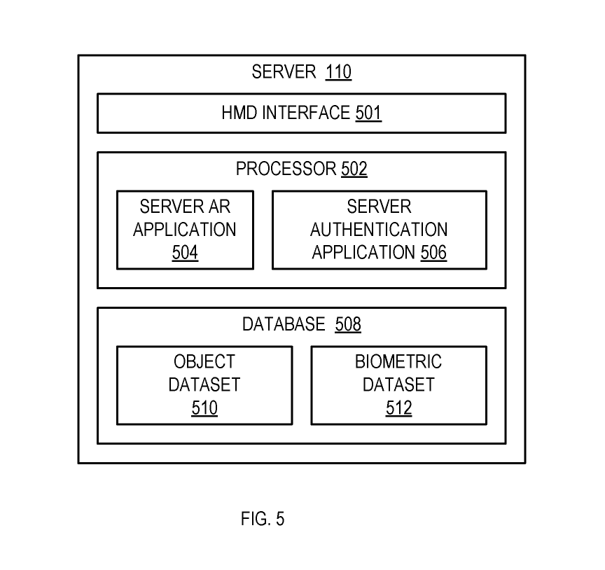

FIG. 5 is a block diagram illustrating modules (e.g., components) of the server 110. The server 110 includes an HMD interface 501, a processor 502, and a database 508. The HMD interface 501 may communicate with the HMD 101 and sensors 112 (FIG. 1) to receive real-time data.

The processor 502 may include a server AR application 504 and a server authentication application 506. The server AR application 504 identifies real-world physical objects A 116, B 118 based on a picture or image frame received from the HMD 101. In another example, the HMD 101 has already identified objects A 116, B 118 and provides the identification information to the server AR application 504. In another example embodiment, the server AR application 504 may determine the physical characteristics associated with the real-world physical objects A 116, B 118. For example, if the real-world physical object A 116 is a gauge, the physical characteristics may include functions associated with the gauge, location of the gauge, reading of the gauge, other devices connected to the gauge, and/or safety thresholds or parameters for the gauge. AR content may be generated based on the real-world physical object A 116 identified and a status of the real-world physical object A 116.

The server authentication application 506 receives biometric data from the HMD 101. The biometric data may be associated with a user wearing the HMD 101. The server authentication application 506 may compare the biometric data from the HMD 101 with biometric data from the database 508 to identify and authenticate a user of the HMD 101. If the server authentication application 506 finds a match with the biometric data from the database 508, the server authentication application 506 retrieves a profile of the user (e.g., user 102) corresponding to the matched biometric data and confirms an identity of the user to the HMD 101. In another example, the server authentication application 506 communicates the profile of the user with the matched biometric data to the HMD 101.

The database 508 may store an object dataset 510 and a biometric dataset 512. The object dataset 510 may include a primary content dataset and a contextual content dataset. The primary content dataset comprises a first set of images and corresponding virtual object models. The contextual content dataset may include a second set of images and corresponding virtual object models. The biometric dataset 512 includes a library of biometric data with an identification of the corresponding user, and access privileges to the virtual objects in the object dataset 510.

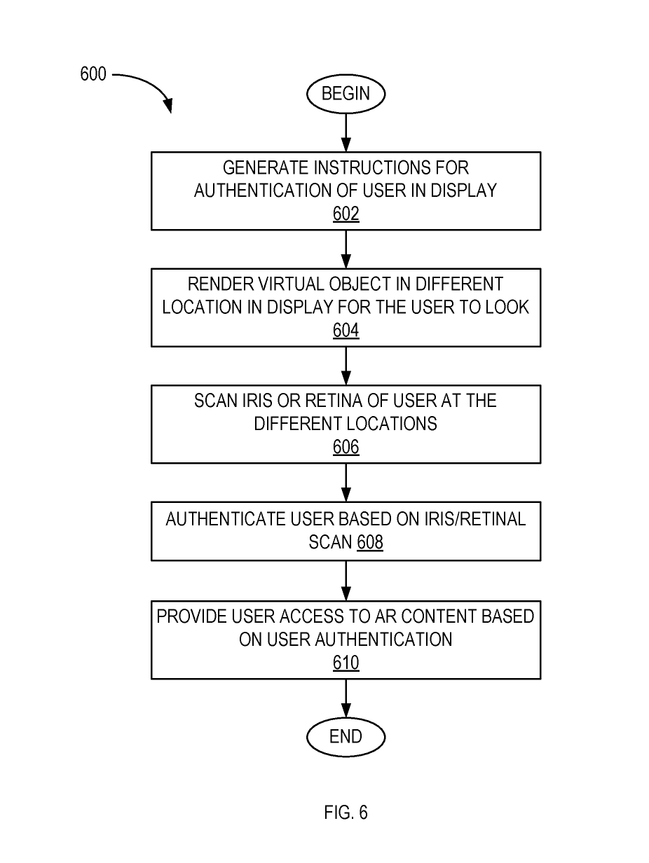

FIG. 6 is a flowchart illustrating a method for operating a biometric authentication application, according to an example embodiment. The method 600 may be deployed on the HMD 101 and, accordingly, is described merely by way of example with reference thereto. At operation 602, the HMD 101 starts an authentication process of the user (wearer) (e.g., user 102) of the HMD 101. The HMD 101 may start the authentication process in response to the user attempting to access virtual content that is restricted to specific personnel of an organization. In another example, the HMD 101 starts the authentication process when the location of the HMD 101 is associated with a geographic boundary that specifies the user to be authenticated prior to providing physical access (e.g., unlocking a door) or prior to providing virtual content related to the geographic boundary.

The HMD 101 generates instructions that are displayed in the display 204 of the HMD 101. The instructions may include requesting the user to stare at different virtual objects in the display 204. The instructions may be provided via audio or visual methods. For example, the user of the HMD 101 may see virtual written instructions in the display 204 or hear audio cues that instruct the user to look at different virtual objects in the display 204. In another example, when a user of the HMD 101 walks towards a restricted area, the HMD 101 may generate an audio alert notifying the user that the user be authenticated prior to entering the restricted area by looking at different virtual objects in the HMD 101.

At operation 604, the HMD 101 renders virtual objects (one at a time) in different locations of the display 204 and requests that the user (e.g., user 102) stare at the virtual objects for a predefined period of time (e.g., 2 seconds). For example, the virtual objects may include arrows, numbers, letters, symbols, and animated two-dimensional or three-dimensional models. The display 204 may be divided into different regions or portions (e.g., top, bottom, left, right, center of the display 204) so that a virtual object is displayed in each region. In one example embodiment, the HMD 101 displays the same virtual object in all regions of the display 204. In another example embodiment, the HMD 101 displays a different virtual object for each region in the display 204. Operation 604 may be implemented, for example, with the AR application 214. The AR application 214 may display the virtual object in the different regions in a sequential order. For example, the AR application 214 starts displaying a first virtual object in the top region of the display 204 for a few seconds (e.g., two seconds) for the user to stare at. The AR application 214 then displays a second virtual object in the right region of the display 204 for another brief period. In the previous example, the AR application 214 displays a different virtual object in a clockwise sequential pattern around the display 204.

A picture of the iris or retina of the user 102 is captured for each region of the display 204 as shown in operation 606. For example, a first picture of the iris is captured when the user 102 stares at a first virtual object displayed in the top region of the display 204. A second picture of the iris is also captured when the user 102 stares at a second virtual object displayed in the right region of the display 204. In one example embodiment, operation 606 may be implemented using the biometric authentication application 216. Therefore, the biometric authentication application 216 captures a number of pictures of the iris or retina of the user 102 equavalent to the number of displayed virtual objects or regions of the display 204. The biometric authentication application 216 may use the ocular camera 306 to capture pictures of the iris or the retina of the user 102. The biometric authentication application 216 may capture a sequence of pictures corresponding to the sequential order of virtual objects displayed in the different regions of the display 204. For example, the biometric authentication application 216 captures first, second, third, and fourth pictures that correspond to the top, right, bottom, and left regions of the display 204.

At operation 608, the HMD 101 identifies and authenticates a user based on the pictures of the irs or retina of the user by comparing the structure of the iris or the blood vessels in the retina with a database of images of iris structures or retina blood vessels. In one example embodiment, operation 608 the HMD 101 may be implemented with the biometric authentication application 216. For example, the biometric authentication application 216 may apply a biometric algorithm to the pictures of the iris or retina captured in the previous operation 606. In one example embodiment, the biometric authentication application 216 applies the biometric algorithm to each picture of the iris or retina to generate biometric data unique to the user of the HMD 101. In another example embodiment, the biometric authentication application 216 combines the biometric data into a composite biometric data that is unique to the user. For example, the biometric authentication application 216 applies a hash algorithm or a statistical algorithm (e.g., median) to the biometric data from all regions to compute the composite biometric data. In another example, the pictures from all regions are combined in a composite picture of the iris or retina. The biometric authentication application 216 applies the biometric algorithm to the composite picture of the iris or retina.

The biometric authentication application 216 compares the biometric data from a region of the display 204 with reference biometric data for the same region of the display 204. The reference biometric data may include biometric data previously obtained from the user 102 of the HMD 101 during a configuration process. For example, the configuration process may include taking pictures of the iris or retina of the user 102, generating biometric data or markers based on the pictures, and storing the biometric data as reference biometric data for the user 102. The reference biometric data may be stored in the storage device 208 of the HMD 101 or in the biometric dataset 512 of the server 110. The user 102 of the HMD 101 is identified and authenticated if the biometric data generated with the biometric authentication application 216 matches the reference biometric data in the storage device 208 or in the biometric dataset 512. In another example embodiment, the biometric authentication application 216 compares composite biometric data with reference composite biometric data in the storage device 208 or in the biometric dataset 512.

At operation 610, the HMD 101 provides the user 102 with access to AR content that is based on the user authentication. For example, the biometric authentication application 216 identifies and authenticates the user 102 of the HMD 101 based on biometric data related to the iris or retina of the user 102. The biometric authentication application 216 determines a privilege access level of the user 102 based on the identification of the user 102. The privilege access level for users may be stored in the storage device 208 of HMD 101 or in the biometric dataset 512 of the server 110. The biometric authentication application 216 determines which virtual content or objects can be displayed based on the privilege access level of the user 102 and communicates to the AR application 214 to render the virtual content.

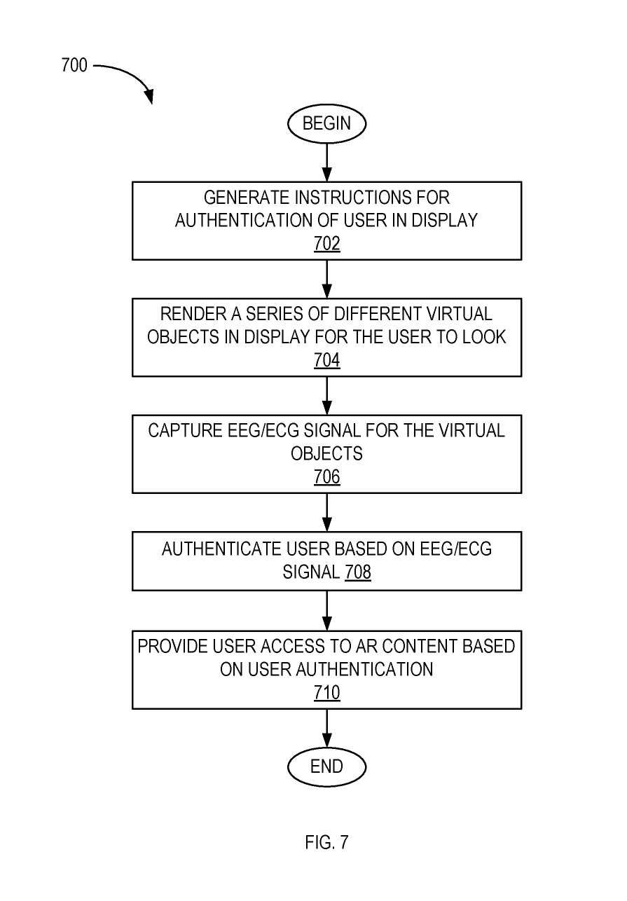

FIG. 7 is a flowchart illustrating a method for operating a biometric authentication application, according to another example embodiment. The method 700 may be deployed on the HMD 101 and, accordingly, is described merely by way of example with reference thereto.

At operation 702, the HMD 101 starts an authentication process of the user (wearer) (e.g., user 102) of the HMD 101. As previously described, the authentication process may start in response to the user attempting to access virtual content that is restricted to specific personnel of an organization.

At operation 702, the HMD 101 generates instructions that are displayed in the display 204 of the HMD 101. The instructions may include, for example, requesting the user 102 to look at different virtual objects displayed in the display 204, listen to different sounds generated by a speaker of the HMD 101, think or focus on a mental picture of an object, take several deep breaths. The user 102 of the HMD 101 may see virtual written instructions in the display 204 or hear audio cues that instruct the user 102 to stand still and look at different virtual objects in the display 204. In another example, when a user 102 of the HMD 101 walks towards a restricted area, the HMD 101 may generate an audio alert to notify the user 102 that the user 102 needs to be authenticated prior to entering the restricted area.

At operation 704, the HMD 101 renders a series of virtual objects in the display 204 and requests that the user 102 stare at the virtual objects for predefined period of time (e.g., 2 seconds). For example, the series of virtual objects may include arrows, numbers, letters, symbols, and animated two-dimensional or three-dimensional models. Each virtual object from the series or set of virtual objects may be displayed one at a time. The display 204 may be also be divided into different regions or portions (e.g., top, bottom, left, right, and center of the display 204) so that a virtual object is displayed in each region. In one example embodiment, the HMD 101 displays the same virtual object in each region of the display 204. In another example embodiment, the HMD 101 displays a different virtual object in each region in the display 204.

Operation 704 may be implemented, for example, with the AR application 214. The AR application 214 may display the series of virtual objects in a sequential order. For example, the AR application 214 starts displaying a first virtual object in the display 204 for a few seconds (e.g., two seconds) for the user 102 to stare at. The AR application 214 then replaces the first virtual object with a second virtual object in the display 204 for another brief period. For example, the AR application 214 displays an animation of a three-dimensional model of a dinosaur for a few seconds before replacing the three-dimensional model of a dinosaur with a three-dimensional model of a waterfall. The series of virtual objects may be displayed in a random or preconfigured order.

EEG signals from the user 102 may be recorded using the EEG sensor 308. ECG signals from the user 102 may be recorded using the ECG sensor 310. In one example embodiment, the EEG sensor 308 and the ECG sensor 310 may be implemented using a set of electrodes in contact with the head of the user 102 wearing the HMD 101. EEG/ECG signals (e.g., brain activity or heart beat) may be captured at operation 706. In one example embodiment, operation 706 may be implemented with the electrode-based module 404. The electrode-based module 404 captures EEG/ECG signals while the user 102 watches a virtual object in the display 204. Therefore, the electrode-based module 404 captures a set of EEG/ECG signals corresponding to each virtual object. For example, a first set of EEG/ECG signals is captured when the user 102 stares at a first virtual object displayed in the display 204. A second set of EEG/ECG signals is captured when the user 102 stares at a second virtual object displayed in the display 204. In one example embodiment, operation 706 may be implemented using the biometric authentication application 216. Therefore, the biometric authentication application 216 captures a number of EEG/ECG signals sets from the user 102 equivalent to the number of virtual objects displayed in the display 204. In another example embodiment, the biometric authentication application 216 may capture a sequence of EEG/ECG signals sets corresponding to the sequential order of virtual objects displayed in the display 204. For example, the biometric authentication application 216 captures a first, second, and third set of EEG/ECG signals that corresponds to first, second, and third virtual objects displayed in the display 204.

At operation 708, the HMD 101 identifies and authenticates a user based on the EEG/ECG signals of the user by comparing the biometric data based on the EEG/ECG signal with a database of images of biometric data. In one example embodiment, operation 708 the HMD 101 may be implemented with the biometric authentication application 216. For example, the biometric authentication application 216 may apply a biometric algorithm to the EEG/ECG signals captured in the previous operation 706 to generate a biometric pattern unique to the user (e.g., user 102). In one example embodiment, the biometric authentication application 216 applies the biometric algorithm to each set of EEG/ECG signals to generate biometric data unique to the user 102 of the HMD 101. In another example embodiment, the biometric authentication application 216 combines the biometric data into a composite biometric data that is unique to the user 102. For example, the biometric authentication application 216 applies a hash algorithm or a statistical algorithm (e.g., median) to the biometric data from all sets of EEG/ECG signals to compute the composite biometric data. In another example, the set of EEC/ECG signal pictures are combined in a composite EEC/ECG signal. The biometric authentication application 216 applies the biometric algorithm to the composite EEC/ECG signal.

The biometric authentication application 216 compares the biometric data corresponding to each virtual object displayed in the display 204 with reference biometric data for the same virtual object. The reference biometric data may include biometric data previously obtained from the user 102 of the HMD 101 during a configuration process. For example, the configuration process may include capturing EEC/ECG signals of the user 102, generating biometric data or markers based on the EEC/ECG signals, and storing the biometric data as reference biometric data for the user 102. The reference biometric data may be stored in the storage device 208 of the HMD 101 or in the biometric dataset 512 of the server 110. The user 102 of the HMD 101 is identified and authenticated if the biometric data generated with the biometric authentication application 216 matches the reference biometric data in the storage device 208 or in the biometric dataset 512. In another example embodiment, the biometric authentication application 216 compares composite biometric data with reference composite biometric data in the storage device 208 or in the biometric dataset 512.

At operation 710, the HMD 101 provides the user (e.g., user 102) with access to AR content that is based on the user authentication. For example, the biometric authentication application 216 identifies and authenticates the user 102 of the HMD 101 based on biometric data related to the brain wave activities/heart beat pattern of the user 102. The biometric authentication application 216 determines a privilege access level of the user 102 based on the identification of the user 102. The privilege access level for users may be stored in the storage device 208 of HMD 101 or in the biometric dataset 512 of the server 110. The biometric authentication application 216 determines which virtual content or objects can be displayed based on the privilege access level of the user 102 and communicates to the AR application 214 to render the virtual content.

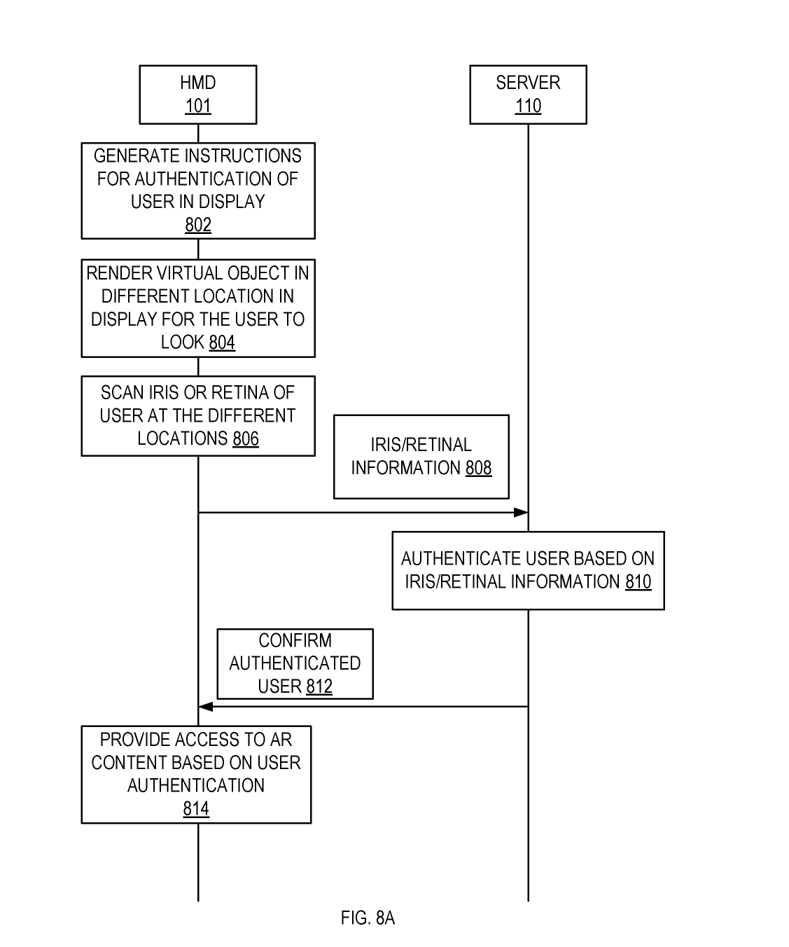

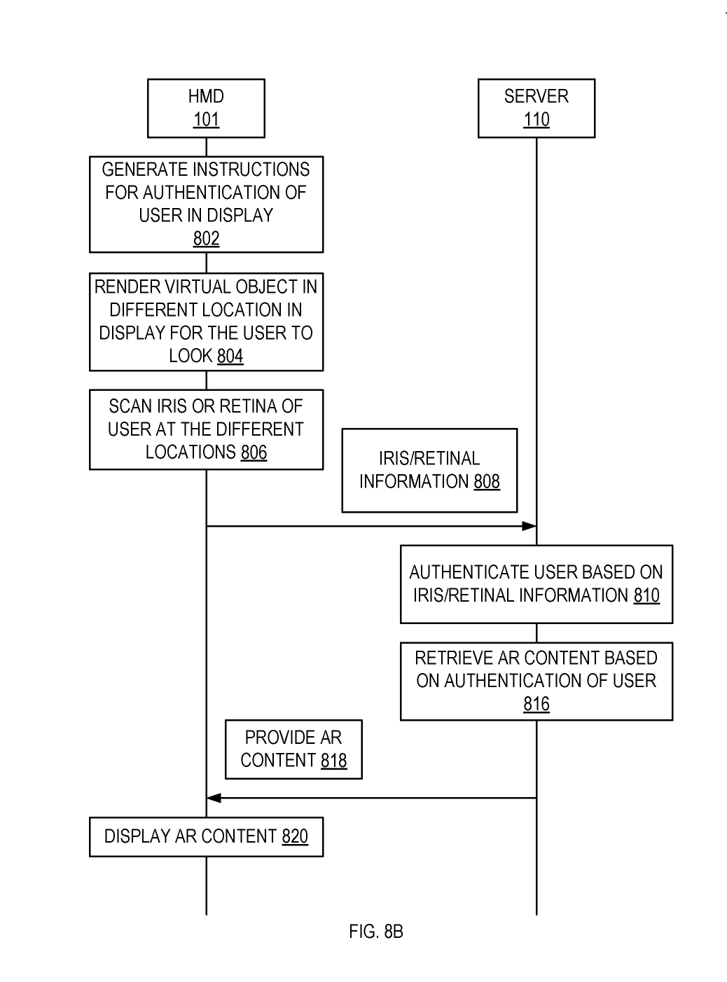

FIG. 8A is an interaction diagram illustrating interactions between a head mounted device (e.g., HMD 101) and a server (e.g., server 110, FIG. 1) for ocular authentication, according to an example embodiment. The HMD 101 may communicate with the server 110 via the network 108. At operation 802, the HMD 101 determines that the user (e.g., user 102) needs to be authenticated in order to access AR content in the HMD 101. The HMD 101 generates and displays instructions in the display 204 of the HMD 101. Examples of instructions include requesting the user to stare at different virtual objects in the HMD 101. The HMD 101 renders different virtual objects in different locations of the display 204 for the user to look at in operation 804. Operation 804 may be implemented with the AR application 214 of the HMD 101. In another example embodiment, the HMD 101 renders a same virtual object in different locations of the display 204. The HMD 101 scans the iris or retina of the user every time the user stares at a different location in the display 204 as shown in operation 806. The captured information from the iris/retinal scan may include pictures of the iris or retina. Operation 806 may be implemented with the biometric authentication application 216 and the biometric sensors 312.

In one example embodiment, the HMD 101 uploads the captured information to the server 110 in operation 808 to authenticate the user of the HMD 101. In another example embodiment, the HMD 101 generates biometric data based on the captured information, and compares the biometric data with reference biometric data locally stored in the HMD 101 to authenticate the user of the HMD 101. If the HMD 101 cannot match the biometric data with any locally stored reference biometric data, the HMD 101 may access the biometric dataset 512 of the server 110. If the HMD 101 determines that there is no match with either reference biometric data from the storage device 208 of the HMD 101, or from the biometric dataset 512 of the server 110, the HMD 101 notifies the user that the user of the HMD 101 cannot be identified and authenticated.

The server 110 receives and compares the biometric data from the HMD 101 with reference biometric data stored in the biometric dataset 512 of the server 110 to identify and authenticate the user of the HMD 101. In one example embodiment, the server 110 communicates with the HMD 101 via HMD interface 501. If the server 110 determines that the biometric data match with one of the reference biometric data in the biometric dataset 512, the server 110 confirms the identity of the authenticated user to the HMD 101 at operation 812.

Once the HMD 101 receives confirmation of the authentication of the user, the HMD 101 determines a level of access of the authenticated user from a database of access privileges and corresponding AR content. For example, users with a first level privilege may have access to a first set of AR content. Users with a second level privilege may have access to a second set of AR content. The second set of AR content may include at least a portion of the first set of AR content. The database of access privileges and corresponding AR content may be stored in the storage device 208 of the HMD 101, in the database 508 of the server 110, or in a combination thereof. In another example embodiment, the server 110 communicates the identity of the user and the corresponding access privilege level of the user to the HMD 101. The HMD 101 provides the authenticated user with access to AR content corresponding to the access privilege of the user at operation 814. The AR application 214 of the HMD 101 may be used to display the AR content associated with the access privilege level of the user in the display 204 of the HMD 101.

FIG. 8B is an interaction diagram illustrating interactions between a head mounted device and a server for ocular authentication, according to another example embodiment. As previously described with respect to FIG. 8A, the HMD 101 generates and displays instructions in the display 204 of the HMD 101 at operation 802. The HMD 101 renders a same virtual object or different virtual objects in different locations of the display 204 for the user to look as shown in operation 804. The HMD 101 scans the iris or retina of the user every time the user stares at a different location in the display 204 as illustrated in operation 806.

In one example embodiment, the HMD 101 uploads the captured information (e.g., picture of the iris/retina) and metadata identifying corresponding virtual object positions in the display 204 to the server 110 in operation 808. The server 110 receives and compares the biometric data from the HMD 101 with reference biometric data stored in the biometric dataset 512 of the server 110 to identify and authenticate the user of the HMD 101 at operation 810.

In another example embodiment, at operation 816, the server 110 determines that the biometric data match with one of the reference biometric data in the biometric dataset 512, and retrieves the AR content associated with the identity of the authenticated user to the HMD 101 from the object dataset 510. The server 110 then provides the retrieved AR content associated with the identity of the authenticated user to the HMD 101 as shown in operation 818. At operation 820, the HMD renders the AR content in the display 204 of the HMD 101.

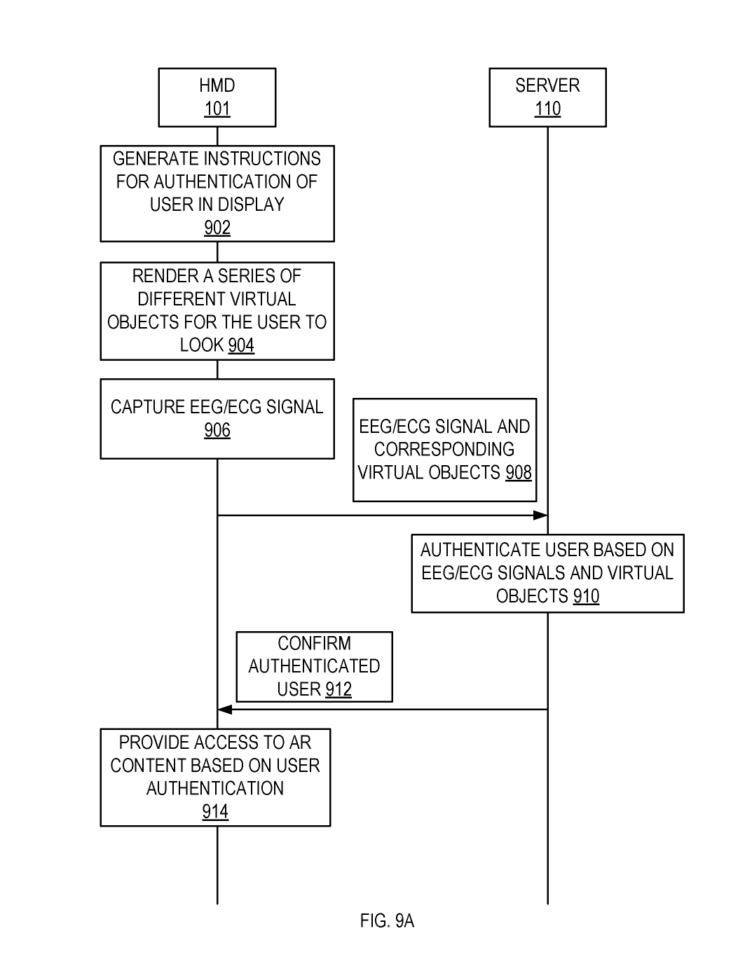

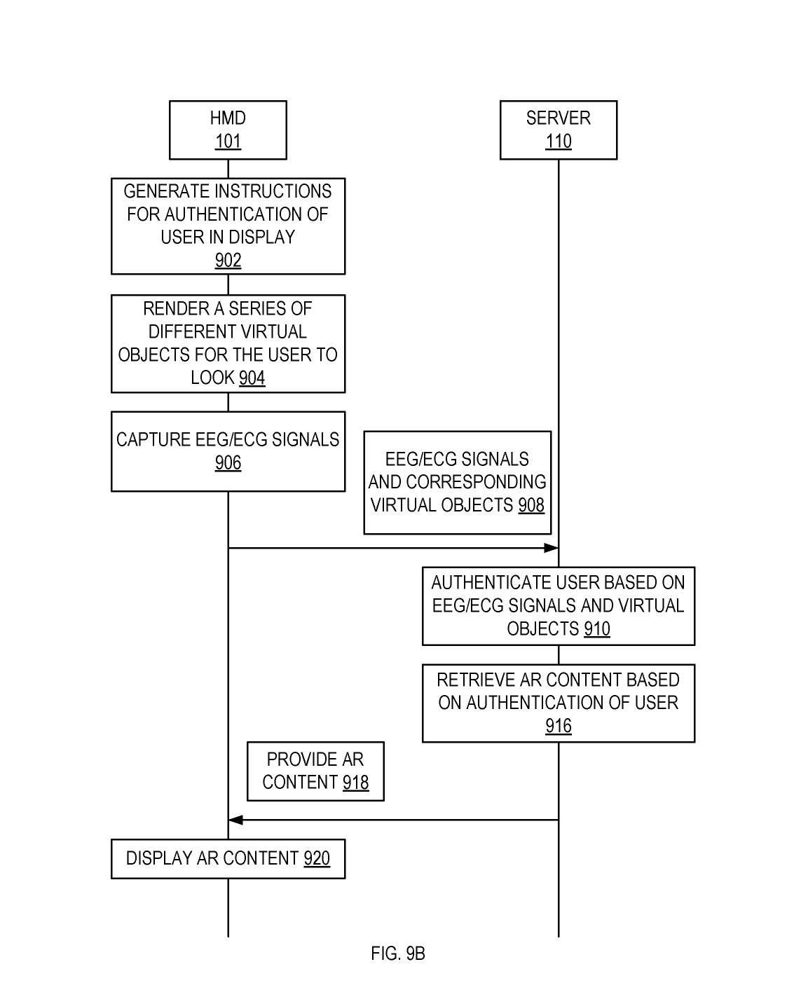

FIG. 9A is an interaction diagram illustrating interactions between a head mounted device and a server for EEG/ECG authentication, according to an example embodiment. The HMD 101 may communicate with the server 110 via the network 108. At operation 902, the HMD 101 generates and displays instructions in the display 204 of the HMD 101 in response to determining that the user may access restricted AR content in the HMD 101. Examples of instructions include requesting the user to look at a series of virtual objects displayed in the display 204 of the HMD 101, to listen to a series of audio cues, or a combination thereof. The HMD 101 renders a series of different virtual objects in the display 204 in operation 904. Operation 904 may be implemented with the AR application 214 of the HMD 101. In another example embodiment, the HMD 101 generates a combination of virtual objects and audio soundtracks. The HMD 101 measures a combination of brain wave activities (e.g., via EEG signals) and heart rate pattern (e.g., via ECG signals) of the user every time a different virtual object is displayed in the display 204 as shown in operation 906. The captured information may include a combination of EEG and ECG signals. Operation 906 may be implemented with the biometric authentication application 216 and the biometric sensors 312.

In one example embodiment, the HMD 101 uploads the captured information to the server 110 in operation 908 to authenticate the user of the HMD 101. In another example embodiment, the HMD 101 generates biometric data based on the captured information, and compares the biometric data with reference biometric data locally stored in the HMD 101 to authenticate the user of the HMD 101. If the HMD 101 cannot match the biometric data with any locally stored reference biometric data, the HMD 101 may access the biometric dataset 512 of the server 110. If the HMD 101 determines that there is no match with either reference biometric data from the storage device 208 of the HMD 101, or from the biometric dataset 512 of the server 110, the HMD 101 notifies the user that the user of the HMD 101 cannot be identified and authenticated.

The server 110 receives and compares the biometric data from the HMD 101 with reference biometric data stored in the biometric dataset 512 of the server 110 to identify and authenticate the user of the HMD 101. In one example embodiment, the server 110 communicates with the HMD 101 via HMD interface 501. If the server 110 determines that the biometric data match with one of the reference biometric data in the biometric dataset 512, the server 110 confirms the identity of the authenticated user to the HMD 101 at operation 910.

The HMD 101 receives confirmation of the authentication of the user at operation 912. After which, the HMD 101 determines a level of access of the authenticated user from a database of access privilege and corresponding AR content as previously described with respect to FIG. 8A. The HMD 101 provides the authenticated user with access to AR content corresponding to the access privilege of the user at operation 914. The AR application 214 of the HMD 101 may be used to display the AR content associated with the access privilege level of the user in the display 204 of the HMD 101.

FIG. 9B is an interaction diagram illustrating interactions between a head mounted device and a server for EEG/ECG authentication, according to another example embodiment. As previously described with respect to FIG. 9A, the HMD 101 generates and displays instructions in the display 204 of the HMD 101 at operation 902. The HMD 101 renders a series of different virtual objects in the display 204 in operation 904. In one example embodiment, the HMD 101 generates a combination of virtual objects and audio soundtracks. At operation 906, the HMD 101 measures a combination of brain wave activities (e.g., via EEG signals) and heart rate pattern (e.g., via ECG signals) of the user every time a different virtual object is displayed in the display 204. The captured information may include a combination of EEG and ECG signals.

In one example embodiment, the HMD 101 uploads the captured information (e.g., EEG/ECG signals) and metadata identifying corresponding virtual object positions in the display 204 to the server 110 in operation 908. The server 110 receives and compares the biometric data from the HMD 101 with reference biometric data stored in the biometric dataset 512 of the server 110 to identify and authenticate the user of the HMD 101 at operation 910.

In another example embodiment, at operation 916, the server 110 determines that the biometric data match with one of the reference biometric data in the biometric dataset 512, and retrieves the AR content associated with the identity of the authenticated user to the HMD 101 from the object dataset 510. The server 110 then provides the retrieved AR content associated with the identity of the authenticated user to the HMD 101 as shown in operation 918. At operation 920, the HMD renders the AR content in the display 204 of the HMD 101.

FIG. 10A is a block diagram illustrating a biometric authentication using an ocular sensor, according to an example embodiment. An eye 1002 of the user 102 stares at virtual content 1008 (e.g., a picture of a balloon) displayed in the transparent display 1004. The display 204 of FIG. 2 may include the transparent display 1004. The AR application 214 of FIG. 2 may be used to generate the virtual content 1008 in a top part of the transparent display 1004. The ocular sensor 1006 may include a camera aimed towards the eye 1002. The camera may be used to capture an image of the structure of the iris or the blood vessel patterns inside the retina in the eye 1002. The ocular sensor 1006 captures an image of the iris or blood vessels in the retina when the eye 1002 is aimed towards the virtual content 1008. This captured image is associated with the relative location of the virtual content 1008 in the transparent display 1004.

FIG. 10B is a block diagram illustrating a biometric authentication using an ocular sensor, according to another example embodiment. The AR application 214 generates another virtual content 1008′ that is displayed in a different location of the transparent display 1004. For example, the virtual content 1008′ may be displayed at a bottom part of the transparent display 1004. The virtual content 1008′ may be different from the virtual content 1008. In another example, the virtual content 1008′ may include the same content as virtual content 1008. The ocular sensor 1006 captures an image of the iris or blood vessels in the retina when the eye 1002 is aimed towards the virtual content 1008′. This captured image is associated with the relative location of the virtual content 1008′ in the transparent display 1004.

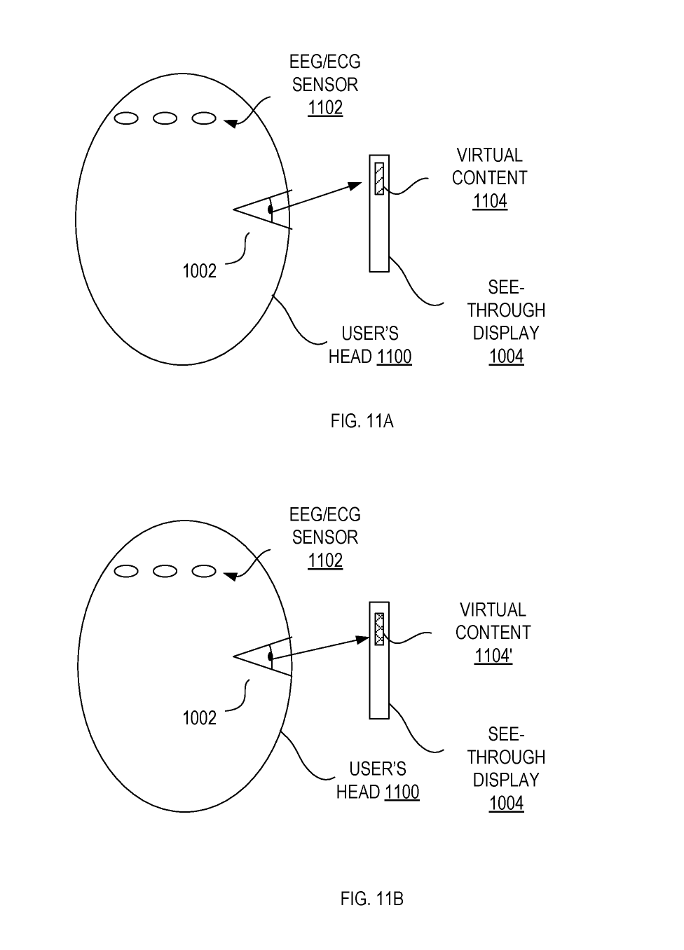

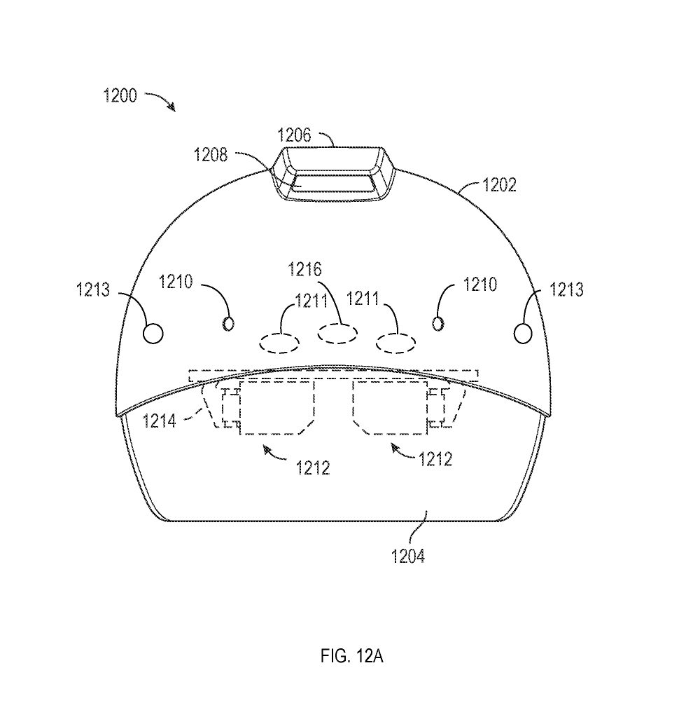

FIG. 11A is a block diagram illustrating a biometric authentication using EEG/ECG sensors, according to an example embodiment. The eye 1002 of a user's head 1100 stares at virtual content 1104 (e.g., a picture of a balloon) displayed in the transparent display 1004. The AR application 214 of FIG. 2 may be used to generate the virtual content 1104 in the transparent display 1004. EEG/ECG sensor(s) 1102 may be connected to the user's head 1110 to measure brain activity and heart rate pattern. The biometric authentication application 216 associates the biometric data from the EEG/ECG sensor(s) 1102 with the virtual content 1104 in the transparent display 1004.

FIG. 11B is a block diagram illustrating a biometric authentication using EEG/ECG sensors, according to another example embodiment. The AR application 214 generates another virtual content 1104′ (in the same or different location of the transparent display 1004). The virtual content 1104′ may be the same or different from the virtual content 1104. The biometric authentication application 216 associates the biometric data from EEG/ECG sensor(s) 1102 with the virtual content 1104′ in the transparent display 1004.

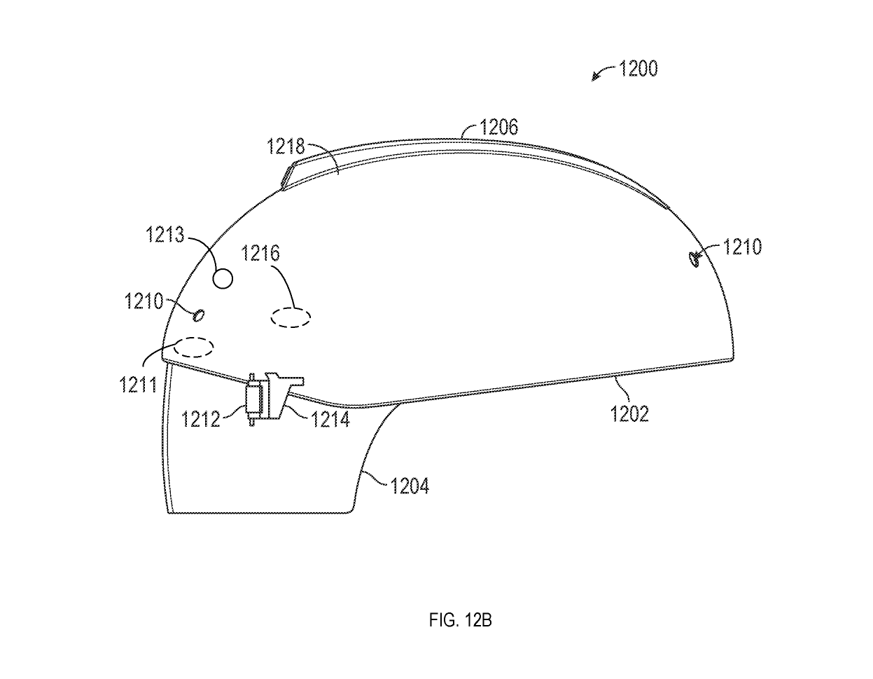

FIG. 12A is a block diagram illustrating a front view of a head mounted device 1200, according to some example embodiments. FIG. 12B is a block diagram illustrating a side view of the head mounted device 1200 of FIG. 12A. The HMD 1200 may include HMD 101 of FIG. 1.

The HMD 1200 includes a helmet 1202 with an attached visor 1204. The helmet 1202 may include sensors 202 (e.g., optical and audio sensors 1208 and 1210 provided at the front, back, and a top section 1206 of the helmet 1202). Display lenses 1212 are mounted on a lens frame 1214. The display lenses 1212 include the display 204 of FIG. 2. The helmet 1202 further includes ocular cameras 1211. Each ocular camera 1211 is directed to an eye of the user 102 to capture an image of the iris or retina. Each ocular camera 1211 may be positioned on the helmet 1202 above each eye and facing a corresponding eye. The helmet 1202 also includes EEG/ECG sensors 1216 to measure brain activity and heart rate pattern of the user 102.

In another example embodiment, the helmet 1202 also includes lighting elements in the form of LED lights 1213 on each side of the helmet 1202. An intensity or brightness of the LED lights 1213 is adjusted based on the dimensions of the pupils of the user 102. The biometric authentication application 216 may control lighting elements to adjust a size of the iris of the user 102. Therefore, the biometric authentication application 216 may capture an image of the iris at different sizes for different virtual objects.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor 212 or a group of processors 212) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor 212 or other programmable processor 212) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 212 configured using software, the general-purpose processor 212 may be configured as respective different hardware modules at different times. Software may accordingly configure a processor 212, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors 212 that are temporarily configured (e.g., by software) or permanently configured to perform the relevant operations. Whether temporarily or permanently configured, such processors 212 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 212 or processor-implemented modules. The performance of certain of the operations may be distributed among the one or more processors 212, not only residing within a single machine, but deployed across a number of machines. In some example embodiments, the processor or processors 212 may be located in a single location (e.g., within a home environment, an office environment or as a server farm), while in other embodiments the processors 212 may be distributed across a number of locations.

The one or more processors 212 may also operate to support performance of the relevant operations in a “cloud computing” environment or as a “software as a service” (SaaS). For example, at least some of the operations may be performed by a group of computers (as examples of machines including processors 212), these operations being accessible via a network 108 and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor 212, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network 108.

In example embodiments, operations may be performed by one or more programmable processors 212 executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers 110. A client and server 110 are generally remote from each other and typically interact through a communication network 108. The relationship of client and server 110 arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor 212), or a combination of permanently and temporarily configured hardware may be a design choice. Below are set out hardware (e.g., machine) and software architectures that may be deployed, in various example embodiments.

### Example Machine Architecture

FIG. 13 is a block diagram of a machine in the example form of a computer system 1300 within which instructions 1324 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server 110 or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions 1324 (sequential or otherwise) that specify actions to be taken by that machine. Further, while only a single machine is illustrated, the term “machine” shall also be taken to include any collection of machines that individually or jointly execute a set (or multiple sets) of instructions 1324 to perform any one or more of the methodologies discussed herein.

The example computer system 1300 includes a processor 1302 (e.g., a central processing unit (CPU), a graphics processing unit (GPU) or both), a main memory 1304 and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alphanumeric input device 1312 (e.g., a keyboard), a user interface (UI) navigation (or cursor control) device 1314 (e.g., a mouse), a disk drive unit 1316, a signal generation device 1318 (e.g., a speaker) and a network interface device 1320.

### Machine-Readable Medium

The disk drive unit 1316 includes a computer-readable medium 1322 on which is stored one or more sets of data structures and instructions 1324 (e.g., software) embodying or utilized by any one or more of the methodologies or functions described herein. The instructions 1324 may also reside, completely or at least partially, within the main memory 1304 and/or within the processor 1302 during execution thereof by the computer system 1300, the main memory 1304 and the processor 1302 also constituting machine-readable media 1322. The instructions 1324 may also reside, completely or at least partially, within the static memory 1306.

While the machine-readable medium 1322 is shown in an example embodiment to be a single medium, the term “machine-readable medium” may include a single medium or multiple media (e.g., a centralized or distributed database, and/or associated caches and servers 110) that store the one or more instructions 1324 or data structures. The term “machine-readable medium” shall also be taken to include any tangible medium that is capable of storing, encoding or carrying instructions 1324 for execution by the machine and that cause the machine to perform any one or more of the methodologies of the present embodiments, or that is capable of storing, encoding or carrying data structures utilized by or associated with such instructions 1324. The term “machine-readable medium” shall accordingly be taken to include, but not be limited to, solid-state memories, and optical and magnetic media. Specific examples of machine-readable media 1322 include non-volatile memory, including by way of example semiconductor memory devices (e.g., erasable programmable read-only memory (EPROM), electrically erasable programmable read-only memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 1324 may further be transmitted or received over a communications network 1326 using a transmission medium. The communications network 1326 may include the same network 108 of FIG. 1. The instructions 1324 may be transmitted using the network interface device 1320 and any one of a number of well-known transfer protocols (e.g., HTTP). Examples of communications networks 1326 include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions 1324 for execution by the machine, and includes digital or analog communications signals or other intangible media to facilitate communication of such software.

Although an embodiment has been described with reference to specific example embodiments, it will be evident that various modifications and changes may be made to these embodiments without departing from the scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A head mounted device (HMD) comprising:
a transparent display;
a biometric sensor configured to measure biometric data of a user of the HMD; and
a processor comprising an augmented reality (AR) application and a biometric authentication application,
the AR application being configured to generate and render a sequence of virtual objects in the transparent display, and
the biometric authentication application being configured to record the biometric data of the user of the HMD for each virtual object of the sequence of virtual objects displayed in the transparent display and to authenticate the user based on the biometric data.

2. The HMD of claim 1, wherein the AR application is configured to render additional virtual objects in the transparent display based on an authentication of the user.

3. The HMD of claim 1, wherein the biometric sensor comprises at least one of an ocular sensor or an electroencephalogram (EEG) sensor.

4. The HMD of claim 1, wherein each virtual object of the sequence of virtual objects is displayed at a different location in the transparent display.

5. The HMD of claim 4, wherein the biometric authentication application is configured to record the biometric data of the user for each different location of the virtual objects in the transparent display, to compare the biometric data of the user for each different location of the virtual objects against reference biometric data of the user for each different location of the virtual objects, wherein the user is authenticated based on the comparison.

6. The HMD of claim 4, wherein the biometric authentication application is configured to record the biometric data of the user for each different location of the virtual objects in the transparent display, to generate composite biometric data based on the biometric data of the user for each different location of the virtual objects, to compare the composite biometric data of the user against reference biometric data of the user, wherein the user is authenticated based on the comparison.

7. The HMD of claim 1, wherein the AR application is configured to render a series of different virtual objects, each different virtual object being displayed in the transparent display.

8. The HMD of claim 7, wherein the biometric authentication application is configured to record the biometric data of the user during rendering of the series of different virtual objects in the transparent display, to compare the biometric data of the user for each virtual object against reference biometric data of the user for each virtual object, wherein the user is authenticated based on the comparison.

9. The HMD of claim 7, wherein the biometric authentication application is configured to record the biometric data of the user during rendering of the series of different virtual objects in the transparent display, to generate composite biometric data based on the biometric data of the user for each virtual object of the series of different virtual objects, to compare the composite biometric data of the user against reference biometric data of the user, wherein the user is authenticated based on the comparison.

10. The HMD of claim 1, wherein the AR application is configured to render a first series of virtual objects and a second series of virtual objects different from the first series of virtual objects, each virtual object of the first series displayed at a different location in the transparent display, each virtual object of the second series displayed in the transparent display,
wherein the biometric authentication application is configured to record ocular biometric data of the user for each different location of the virtual objects of the first series in the transparent display, and to compare the ocular biometric data of the user for each different location of the virtual objects of the first series against reference biometric data of the user for each different location of the virtual objects of the first series,
wherein the biometric authentication application is configured to record EEG biometric data of the user for the second series of virtual objects in the transparent display, and to compare the EEG biometric data of the user for each virtual object of the second series against reference biometric data of the user for each virtual object of the second series.

11. A method comprising:
measuring biometric data of a user of an HMD with a biometric sensor;
generating and rendering, using a processor of the HMD, a sequence of virtual objects in a transparent display of the HMD;
recording the biometric data of the user of the HMD for each virtual object of the sequence of virtual objects displayed in the transparent display; and
authenticating the user based on the biometric data.

12. The method of claim 11, further comprising:
rendering additional virtual objects in the transparent display based on an authentication of the user.

13. The method of claim 11, wherein the biometric sensor comprises at least one of an ocular sensor or an electroencephalogram (EEG) sensor.

14. The method of claim 11, wherein each virtual object of the sequence of virtual objects is displayed at a different location in the transparent display.

15. The method of claim 14, further comprising:
recording the biometric data of the user for each different location of the virtual objects in the transparent display; and
comparing the biometric data of the user for each different location of the virtual objects against reference biometric data of the user for each different location of the virtual objects, wherein the user is authenticated based on the comparison.

16. The method of claim 14, further comprising:
recording the biometric data of the user for each different location of the virtual objects in the transparent display;
generating composite biometric data based on the biometric data of the user for each different location of the virtual objects; and
comparing the composite biometric data of the user against reference biometric data of the user, wherein the user is authenticated based on the comparison.

17. The method of claim 11, further comprising:
rendering a series of different virtual objects, each different virtual object being displayed in the transparent display.

18. The method of claim 17, further comprising:
recording the biometric data of the user during rendering of the series of different virtual objects in the transparent display; and
comparing the biometric data of the user for each virtual object against reference biometric data of the user for each virtual object, wherein the user is authenticated based on the comparison.

19. The method of claim 17, further comprising:
recording the biometric data of the user during rendering of the series of different virtual objects in the transparent display;
generating composite biometric data based on the biometric data of the user for each virtual object of the series of different virtual objects; and
comparing the composite biometric data of the user against reference biometric data of the user, wherein the user is authenticated based on the comparison.

20. A non-transitory machine-readable medium comprising instructions that, when executed by one or more processors of a machine, cause the machine to perform operations comprising:
measuring biometric data of a user of an HMD with a biometric sensor;
generating and displaying a sequence of virtual objects in a transparent display of the HMD;
recording the biometric data of the user of the HMD for each virtual object of the sequence of virtual objects displayed in the transparent display; and
authenticating the user based on the biometric data.
